(19) United States
(12) Patent Application Publication
(10) Pub. No.: US 2007/0117909 A1
(43) Pub. Date: May 24, 2007

(54) PROCESS FOR FORMING A REINFORCED POLYMERIC MATERIAL AND ARTICLES FORMED THEREWITH

(75) Inventors: James T. Seliskar, Bay City, MI (US); Norwin Van Riel, Aardenburg (NL)

Correspondence Address: DOBRUSIN & THENNISCH PC, 29 W. LAWRENCE STREET, STE. 210, PONTIAC, MI, 48342, US

(73) Assignee: Dow Global Technologies Inc., Midland, MI (US)

(21) Appl. No.: 11/549,751

(22) Filed: Oct. 16, 2006

Related U.S. Application Data
(60) Provisional application No. 60/730,799, filed on Oct. 27, 2005.

(51) Int. Cl. C08K 3/40

(52) U.S. Cl. 524/494

(57) ABSTRACT

A process is employed to formed a reinforced polymeric material and articles having the reinforced polymeric material. The process typically forms a masterbatch of polymeric material and reinforcement material and combines the masterbatch with secondary materials that include a second polymeric material. The process is particularly applicable to styrenic polymers.

### CLAIM OF BENEFIT OF FILING DATE

The present application claims the benefit of the filing date of U.S. Provisional Application Ser. No. 60/730,799, filed Oct. 27, 2005, hereby incorporated by reference.

### TECHNICAL FIELD

The present invention is directed toward a process for preparing reinforced polymeric materials and parts.

### BACKGROUND OF INVENTION

It is well known that the physical properties of thermoplastics can be improved by the incorporation of filler materials such as glass fibers. The incorporation of reinforcing fibers into polymeric products can beneficially affect resin properties such as tensile strength, stiffness, dimensional stability, resistance to creep and thermal expansion.

Traditional methods of producing such articles have used precompounded short fiber glass-filled polymer such as acrylonitrile butadiene styrene (ABS) or styrene maleic anhydride (SMA). While satisfying certain objectives in optimizing the quality of the finished product, conventional methods have drawbacks. Conventional methods can become quite costly and processing difficulties can be encountered particularly depending upon the materials being processed and the techniques used for processing. As one example, conventional materials employed during processing can exhibit properties such as relatively low ductility, toughness, strength, combinations thereof or the like and, in turn, processing of the the materials can cause detrimental effects such as breakage, lack of consistency, waste or the like. Moreover, conventional materials and processing have, in certain circumstances, negatively affected properties such as density, impact performance, toughness, ductility, strength, combinations thereof or the like for articles formed with the materials or processes.

Certain steps have been taken in overcoming the deficiencies of known methods by incorporating long glass fibers into thermoplastic material for producing a long fiber-reinforced thermoplastic article. See, WO 01/02471, titled LONG FIBER-REINFORCED THERMOSPLASTIC MATERIAL AND METHOD FOR PRODUCING THE SAME incorporated herein by reference for all purposes. Further, see, WO/0003852, titled GRANULES FOR THE PRODUCTION OF A MOLDING WITH A CLASS-A SURFACE, PROCESS FOR THE PRODUCTION OF GRANULES AND ITS USE also incorporated herein by reference for all purposes. Still further, see, U.S. Pat. No. 5,783,129, titled APPARATUS, METHOD, AND COATING DIE FOR PRODUCING LONG FIBER-REINFORCED THERMOPLASTIC RESIN COMPOSITION and U.S. Pat. No. 5,788,908 for METHOD OF PRODUCING FIBER-REINFORCED THERMOPLASTIC RESIN COMPOSITION, both of which are also incorporated herein by reference for all purposes. In the interest of continuing innovation in the field of reinforced polymers, the present invention provides a process for forming reinforced polymeric material and articles formed with the polymeric material wherein the process or article overcome one of the aforementioned drawbacks (e.g., high costs, lack of durability) or other drawbacks.

### SUMMARY OF THE INVENTION

The present invention provides a method for forming a reinforced polymeric material and a material and articles formed with method and/or material. According to the method, materials suitable for forming a masterbatch are provided and typically include a first polymeric material and a reinforcement material. In a preferred embodiment, the the first polymeric material is a mixture of SAN and ABS, the mixture is provided in a ratio of between about 10:1 to about 1:10 of ABS to SAN. The reinforcement material includes fibers, although not required. These materials are then processed to form the masterbatch by combining the first polymeric material with the reinforcement material. Once formed, the masterbatch is then typically combined or mixed with one or more secondary materials to form an admixture. Typically, the secondary materials include a styrenic polymer.

### DESCRIPTION OF THE DRAWINGS

FIG. 1 is a flowchart illustrating one exemplary embodiment of a method according to the present invention.

### DETAILED DESCRIPTION OF THE PREFERRED EMBODIMENT

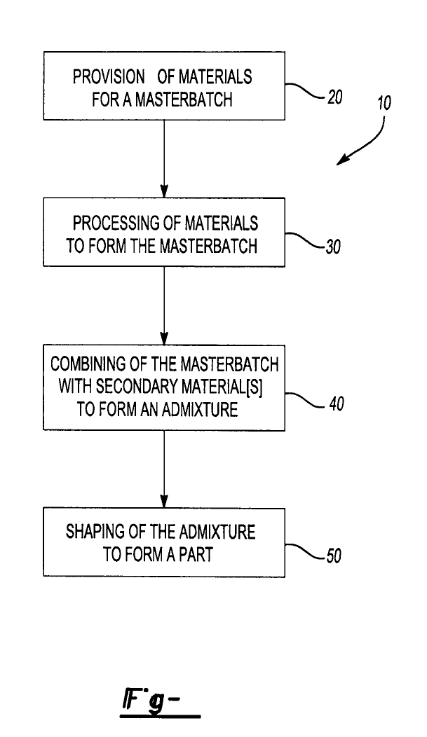

The present invention is predicated upon the provision of a process for forming a masterbatch of material, which can be used in the formation of a reinforced polymeric material. The present invention is also predicated upon the formation of the reinforced polymeric material itself and parts formed with the reinforced polymeric material. With reference to FIG. 1, there is illustrated a process 10 according the present invention. As can be seen, the process 10 typically includes a combination of the following steps:
i) provision (20) of materials (e.g., a polymeric material and reinforcement material) for forming a masterbatch;
ii) processing (30) of the materials to form the masterbatch (e.g., pellets of the polymeric material and and the reinforcement material);
iii) mixing (40) of the masterbatch with at least one secondary material (e.g., neat mass ABS) to form an admixture;
iv) shaping (50) of the admixture to form a part such as a part for an automotive vehicle.

The methodologies of the present invention have been found particularly useful for processing styrenic materials and more specifically styrenic coplymers such as acrylonitrile-butadiene-styrene (ABS), styrene-acrylonitrile (SAN), combinations thereof or the like.

Masterbatch Materials (20)

Typically the masterbatch includes one or more polymeric materials and one or more reinforcement materials. It is also typical for the one or more polymeric materials to include one or more toughening agents. Generally, it is contemplated that a number of different polymers or copolymers can be included in the one or more polymeric materials.

Examples of suitable polymeric materials can include, without limitation, polyolefins, polyurethanes, polystyrenes, polyesters, polypropylenes, elastomers, polyamides, polystyrenes, polycarbonates, combinations thereof or the like. Generally, it is preferable for the polymeric materials to be thermoplastics and/or elastomers, although not required. The polymeric materials typically comprise at least 10%, more typically at least 25%, still more typically at least 45% and even more typically at least 60% by weight of the masterbatch and are also typically less than about 90%, more typically less than about 80% and even more typically less than about 70% by weight of the masterbatch. Of course, higher or lower weight percentages may also be used.

According to one preferred embodiment, the one or more polymeric materials include at least one styrenic material or a combination of two or more styrenic materials. Examples of particularly preferred styrenic materials include, without limitation, styrene-acrylonitrile (SAN) such as Tyril® (trademark. The Dow Chemical Company) or acrylonitrile-butadiene-styrene (ABS) such as MAGNUM® (trademark, The Dow Chemical Company) or a styrene-maleic anhydride (SMA) such as DYLARK˜(trademark, Nova Chemicals). Generally, it is desirable for the one or more polymeric materials to be relatively high flow materials such that they can act as a carrier for the reinforcement material. As a variation to the use of a styrenic-based carrier, alternate high flow engineering thermoplastic resins may be used or blended with the styrenic based carrier such as polycarbonate (PC) such as CALIBRE® (trademark, The Dow Chemical Company) or a thermoplastic polyurethane such as ISOPLAST® (trademark, The Dow Chemical Company).

It is generally contemplated that the masterbatch could be entirely ABS or entirely SAN. However, in a preferred embodiment, a mixture of ABS and SAN are a substantial portion of the polymeric material or masterbatch. Typically, when included, the mixture is at least about 50%, more typically at least about 80% and even more typically at least about 90% by weight of the masterbatch. For such a mixture, it is contemplated that the ABS may be provided as mass ABS or emulsion ABS. When provided as an emulsion, the mixture typically includes a ratio of ABS to SAN that is between about 1:5 and about 5:1, more typically between about 3:5 and about 5:3 and even more typically between about 4:5 and about 5:4. When provided as mass ABS or neat mass ABS, the ratio of ABS to SAN is typically between about 20:1 and about 1:1, more typically between about 10:1 and about 2:1 and even more typically between about 6:1 and about 4:1.

Preferred types of SAN for the masterbatch will typically have a melt flow rate of between about 18 and 31 grams/10 minutes at 230° C. under a 3.8 Kg load. Preferred types of ABS, particularly emulsion ABS for the masterbatch will have having a melt flow rate of between 3 and 9 about grams/10 minutes at 230° C. under a 3.8 Kg load. Of course, higher or lower melt flow rates may also be employed.

As suggested the one or more polymeric materials may be a blend of two or more polymeric materials. In one embodiment, the polymeric materials of the masterbatch include one or more toughening agents. The toughening agent is preferably an elastomer or rubber, although not required unless otherwise stated. When included, the toughening agent[s] are at least 0.5%, more typically at least 1.0%, still more typically at least 2.5% and even more typically at least least 4.0% by weight of the masterbatch and are also typically less than about 30%, more typically less than about 18% and even more typically less than about 10% by weight of the masterbatch. Of course, higher or lower weight percentages may also be used.

Examples of suitable elastomers for use as a toughening agent include nitrites, butadienes, EPDMs, halogenated elastomers (e.g., chloro- and fluoro-elastomers), silicone elastomers, polyurethane elastomers, latex, thermoplastic elastomers, olefinic elastomers and natural rubbers. One preferred toughening agent is polybutadiene rubber, which may be provided as part of a grafted rubber compound (e.g., emulsion ABS)

It is also contemplated that a substantial portion or substantially the entirety of the polymeric material is provided through the mixing of ABS with a pre-mix of a styrenic material compounded with a toughening agent. An example of such an pre-mix is an SAN/toughening agent premix which can be provided as emulsion ABS. Generally, the pre-mix can use any toughening agent described herein. Typically, such a pre-mix includes at least 1.0%, more typically at least 2.0%, still more typically at least 5.0% and even more typically at least 8.0% by weight toughening agent and also typically includes less than about 50%, more typically less than about 20% and even more typically less than about 15% by weight toughening agent. Of course, higher or lower weight percentages may also be used. One preferred SAN/toughening agent pre-mix is sold under the tradename MAGNUM® 9020 or 2620 (trademark, the Dow Chemical Company), which can be diluted as necessary to attain the desired amount of SAN relative to toughening agent in the pre-mix. When an emulsion ABS or SAN/toughening agent premix is employed, the ratio of emulsuion ABS to SAN is typically between about 5:1 and about 1:5, more typically between about 3:1 and about 1:3 and even more typically between about 2:1.5 and about 1.5:2 (e.g., about 1:1).

The masterbatch also typically includes one or more reinforcement materials. Exemplary reinforcement materials can include, without limitation, minerals, weaves, fibers etc. Fibers or fibrous materials are particularly preferred for the present invention. Exemplary fibers include, without limitation, polymeric fibers, metal fibers, carbon fibers, graphite fibres, ceramic fibers or combinations thereof. Specific examples include without limitation, polyamide (e.g., nylon, aromatic polyamide and polyamideimide) fibers, aramid fibers, polyester fibers, glass fibers, silicon carbide fibers, alumina fibers, titanium fibers, steel (e.g., stainless steel) fibers, carbon fibers, natural fibers (e.g., jute) and graphite fibers or the like. It is also contemplated that reinforcement may be provided using the above materials but in a different form, such as chopped fiber, particulate, foam, woven, or unwoven fabric, mat, cordage, or otherwise.

Typically, the masterbatch includes a substantial portion of glass fibers and it is contemplated that the reinforcement material may be substantially entirely or entirely glass fibers. The reinforcement material is typically at least 10%, more typically at least 25%, still more typically at least 45% and possibly at least least 60% by weight of the masterbatch and is also typically less than about 90%, more typically less than about 80% and even more typically less than about 70% by weight of the masterbatch. Of course, higher or lower weight percentages may also be used. It is also contemplated that the glass fibers may include a sizing agent, although not required unless otherwise specified.

Masterbatch Formation (30)

Formation of the masterbatch generally includes combining or intermixing of the one or more polymeric materials with the one or more reinforcement materials. Many mixing techniques may be employed for combining the materials of the masterbatch depending upon the desired manner in which the masterbatch is to be provided. As an example the polymeric materials may be melted such that the reinforcement material can be introduced to the polymeric materials while in liquid form. Alternatively, the reinforcement material and the polymeric materials may be intermixed as solids. In a prefered embodiment, the materbatch is preferably formed as pellets that include the reinforcement material (e.g. fibers) at least partially or substantially entirely encapsulated in the polymeric materials.

For forming such pellets, the reinforcement material can be submerged in the polymeric material or the polymeric material can be coated onto the reinforcement material such as by spray coating, drip coating or the like. According to one preferred embodiment, the one or more polymeric materials are compounded onto reinforcement material such that the polymeric materials whet and adhere to the reinforcement material. In such a compounding process, the reinforcement material is provided to a die or other structure of a compounding unit or machine (e.g, a pultrusion, extrusion or coextrusion machine) as a continuous feed or side feed of bundled fibers (e.g., glass fibers) and the polymeric materials are also provided to the die of the compounding device as a carrier melt such the the polymeric materials substantially encapsulate, whet and adhere to the fibers for forming the material of the masterbatch. Thereafter, the material of the masterbatch is cut to form the masterbatch into pellets that substantially encapsulate the fibers. The average length of the fibers formed according to this process and for the masterbatch in general is at least at least 1 mm, more typically at least 3 mm, still more typically at least 5 mm and possibly at least 10 mm and is also typically less than about 50 mm, more typically less than about 30 mm and even more typically less than about 18 mm. Of course, higher or lower lengths may also be used.

Admixture Formation (50)

Generally, formation of the admixture involves combining of masterbatch with one or more secondary materials. The secondary materials will typically include at least one polymeric material. Potential suitable polymeric materials include, without limitation, polyolefins, polyurethanes, polystyrenes, polyesters, polypropylenes, elastomers, polyamides, polystyrenes, polycarbonates, combinations thereof or the like.

It is prefereable that the secondary materials include or are substantially entirely comprised of one or more polymers or copolymers that are stiffer than the polymeric materials of the masterbatch and which are typically unreinforced, although none of these characteristics are required unless otherwise stated. It is also preferable, although not required, for these polymers or copolymers to include a substantial portion or substantially entirely one or more stryrenic materials such as ABS, acrylate styrene acrylonitrile (ASA), AIBS, SMA or alloys of these copolymers such as PC/ASA, PC/ABS, or PC/SMA.

In a highly preferred embodiment the secondary materials are comprised substantially entirely of one or more neat mass styrenic materials such as neat mass ABS. This neat polymer will typically contribute to the strength and heat resistance of the admixture or parts formed therewith althougth not required. One example of a preferred neat mass ABS, which is typically a high heat ABS, is sold under the tradename MAGNUM BRACE® 5500.

Combination of the secondary material or materials with the masterbatch may, like forming the masterbatch, be accomplished using multiple different techniques or protocols. As an example the secondary materials may be melted such that the masterbatch can be introduced thereto. Alternatively, the masterbatch and the one or more secondary materials may be combined and/or intermixed as solids.

In a prefered embodiment, the materbatch is dry blended with the one or more secondary materials. Various dry blending techniques may be employed such as mixing in a volumetric mixer or otherwise.

In one preferred embodiment, the masterbatch and the secondary material[s] are provided as masses or pellets to a gravimetric mixer. Typically, the masterbatch is provided as at least about 5%, more typically at least 13%, still more typically at least 19%, and possibly at least about 22% by weight of the admixture and is also typically provided as less than about 50%, more typically less than about 35% and even more typically less than about 28% by weight of the admixture. Typically, the masterbatch is provided as at least about 30%, more typically at least 50%, still more typically at least 67%, and possibly at least about 72% by weight of the admixture and is also typically provided as less than about 95%, more typically less than about 88% and even more typically less than about 79% by weight of the admixture. Of course, higher or lower weight percentages may also be used. Provision of the masterbatch, the secondary material[s] or both to the mixer may be accomplished by multiple different techniques such as gravity feeding, use of air pressure or the like. Preferably, however, the masterbatch and the secondary material[s] are vacuum pulled through tubular structures to the mixtures. Advantageous, the pellets of the masterbatch formed according to techniques of the present invention often maintain greater integrity relative to pellets formed according to other techniques.

As another alternative, it is contemplated that the masterbatch and the one or more secondary materials may be fed directly to a part forming unit such that the admixture is formed in the part forming unit (e.g., injection molding machine). Part formation is further discussed below.

It is possible for the masterbatch, the admixture or both to include chemical coupling agent, compatibilizer or both, which can be comprised of one or more different coupling agents or compatibilizers. However, in one preferred embodiment, the masterbatch is substantially without any coupling agent, compatibilizer or both (e.g., includes less than 3%, 1%, or 0.2% or even less than 0.01% coupling agent, compatibilizer or both).

Part Formation (60)

The resulting admixture can be shaped according to a variety of techniques and using a variety of part forming units (e.g., injection, blow or compression molding machines) for producing a structure or part of an article of manufacture such as an automotive vehicle. As examples, it is contemplated that the admixture can be molded (e.g., compression molded, blow molded, injection molded or the like), extruded, pultruded, combinations thereof or the like for forming a part having a desired shape.

The admixture has been found to be particularly useful in forming injection molded parts. Typically, after injection molding, the parts have an average fiber length that is shorter than the average fiber length of the admixture prior to injection molding. Average fiber length after injection molding is typically at least 0.2 mm, more typically at least 0.6 mm and even more typically at least 0.8 mm and is typically less than 10 mm, more typically less than 4 mm, and even more typically less than 2.0 mm and still more typically less than 1.2 mm. Of course, higher or lower length are additionally contemplated. It is also contemplated that the the injection molding process can be modified to produce less shortening of the fibers, for instance through use of screws with extended transition zones and/or through the use of low or no back pressure. The parts removed from the injection mold machine often exhibit one or more desirable properties. As examples, techniques of the present invention can be used to provide parts having one or more of the following improved properties: greater ductility; greater strength; better heat performance; greater toughness; combinations thereof or the like. As another advantage, the masterbatch, the admixture or both can exhibit improved processability. Moreover, the parts formed from the material can provide a class A or class B surface, which can be particularly useful for automotive vehicles.

While particular materials have been discussed for the present invention, it is contemplated that various additives may also be introduced to the masterbatch, the admixture or precursors thereof during any of the processing steps discussed herein. Such additives can include, without limitation, colorants, dc-molding agents, anti-oxidants, UV stabilizers, fire retardants, compatiblizers, surfactants, inorganic fillers, combinations thereof or the like.

The process of the present invention is illustrated by the following practical example and comparative testing wherein all parts and percentages are by weight unless otherwise specified.

### PRACTICAL EXAMPLE

A long glass fiber master-batch is prepared using glass roving (e.g., TUFROV®) 4588 or 4599, Trademark PPG Industries) added, via a pultrusion or co-extrusion process, into a relatively high flow melt of 50% SAN (e.g., SAN 125 having a melt flow rate of 25 grams/10 minutes at 230° C. under a 3.8 Kg load) and 50% Emulsion ABS (e.g., Magnum 9020 having a melt flow rate of 6 grams/10 minutes at 230° C. under a 3.8 Kg load) and formed into pellets. The obtained glass fiber content in the master-batch is between 40% percent and 60% percent. This master-batch is dry-blended with several neat mass ABS resins in blending ratios between 15 percent and 35 percent to form an admixture. The dry-blend is then used for molding articles in an injection molding machine under standard ABS conditions.

Additional materials and techniques, which may be employed in the practice of the present invention are disclosed in PCT Application WO 2005/090451, which is expressly incorporated herein by reference for all purposes.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims. In particular regard to the various functions performed by the above described components, assemblies, devices, compositions, techniques etc., the terms used to describe such items are intended to correspond, unless otherwise indicated, to any item that performs the specified function of the described item, even though not necessarily structurally equivalent to the disclosed structure. In addition, while a particular feature of the invention may have been described above with respect to only one of the embodiments, such feature may be combined with one or more other features of other illustrated embodiments.

What is claimed is:

1. A method of forming a reinforced thermoplastic, comprising:
providing materials suitable for forming a masterbatch, the materials including a first polymeric material and a reinforcement material, wherein:
i. the first polymeric material is a mixture of SAN and ABS, the mixture being provided in a ratio of between about 10:1 to about 1:10 of ABS to SAN; and
ii. the reinforcement material includes fibers;
processing the materials to form the masterbatch by combining the first polymeric material with the reinforcement material; and
mixing the masterbatch with one or more secondary materials to form an admixture, the secondary materials including a styrenic polymer.

2. A method as in claim 1 wherein the ratio is about 5:4 to about 4:5 of ABS to SAN.

3. A method as in claim 1 wherein the ABS is provided as a pre-mix of ABS and toughening agent, the toughening agent being an elastomer.

4. A method as in claim 1 wherein the ABS is provided as emulsion ABS.

5. A method as in claim 1 wherein the reinforcement material is provided as multiple unwoven glass fibers bundled together, each of the glass fibers having a diameter less than about 20 angrstroms.

6. A method as in claim 1 wherein the reinforcement material and the first polymeric material are fed to a pultrusion machine such that the first polymeric material whets and adheres to the reinforcement material to form a polymeric coated reinforcement material.

7. A method as in claim 6 wherein the polymeric coated reinforcement material is further processed to form the masterbatch as pellets of the polymeric coated reinforcement and the pellets have an average glass fiber length of between about 3 and about 30 mm.

8. A method as in claim 1 wherein the secondary materials consist essentially of neat mass ABS resin.

9. A method as in any of claims 1 wherein the one or more secondary materials are mixed with the masterbatch in a gravimetric blender to provide homogeneity to the admixture.

10. A method as in any of claims 1 wherein the admixture includes about 10 to about 40 weight % masterbatch and about 60 to about 90 weight % of the one or more secondary materials.

11. A method as in any of claims 1 further comprising shaping the admixture into a part.

12. A method as in claim 11 wherein the part is for a transportation vehicle.

13. A method as in claim 11 wherein the part is shaped by injecting molding the admixture.

14. A method as in claim 13 wherein injection molding is performed with relatively low back pressure and extended transition zone screws.

15. A method of forming a part for an automotive vehicle, comprising:
providing materials suitable for forming a masterbatch, the materials including a first polymeric material and a reinforcement material, wherein:
i. the first polymeric material is a mixture of SAN and ABS, the mixture being provided in a ratio of between about 10:1 to about 1:10 of ABS to SAN;
ii. the reinforcement material being provided as multiple general unwoven glass fibers;
processing the materials to form the masterbatch by combining the first polymeric material with the reinforcement material, wherein:
i. the reinforcement material and the first polymeric material are combined such that the first polymeric material whets and adheres to the reinforcement material to form a polymeric coated reinforcement material;
ii. the polymeric coated reinforcement material is further processed to form the masterbatch as pellets of the polymeric coated reinforcement; and
iii. the pellets having an average glass fiber length of between about 3 and about 30 mm; and
mixing the masterbatch with one or more secondary materials to form an admixture, the one or more secondary materials including ABS resin, wherein:
i. the admixture includes about 10 to about 40 weight % masterbatch and about 60 to about 90 weight % of the one or more secondary materials;
shaping the admixture into a part of an automotive vehicle by injection molding the admixture.

16. A method as in claim 15 wherein the part is molded to have a class A or a class B surface.

17. A method as in claim 15 wherein the masterbatch, the admixture or both are substantially without coupling agent, compatibilzer or both.

18. A method of forming a part for a automotive vehicle, comprising:
providing materials suitable for forming a masterbatch, the materials including a first polymeric material and a reinforcement material, wherein:
i. the first polymeric material is a mixture of SAN and ABS, the mixture being provided in a ratio of between about 5:4 to about 4:5 of ABS to SAN, the ABS being provided as an emulsion;
ii. the reinforcement material being provided as multiple general unwoven glass fibers bundled together as a roving, each of the glass fibers having a diameter less than about 20 angrstroms;
processing the materials to form the masterbatch by combining the first polymeric material with the reinforcement material, wherein:
i. the reinforcement material and the first polymeric material are fed to a pultrusion machine such that the first polymeric material whets and adheres to the reinforcement material to form a polymeric coated reinforcement material;
ii. the polymeric coated reinforcement material is further processed to form the masterbatch as pellets of the polymeric coated reinforcement; and
iii. the pellets having an average glass fiber length of between about 3 and about 30 mm; and
mixing the masterbatch with one or more secondary materials to form an admixture, the secondary materials consisting essentially of neat mass ABS resin, wherein:
i. the one or more secondary materials are mixed with the masterbatch in a gravimetric blender to provide homogeneity to the admixture; and
ii. the admixture includes about 10 to about 40 weight % masterbatch and about 60 to about 90 weight % of the one or more secondary materials;
shaping the admixture into a part of an automotive vehicle by injection molding the admixture, wherein:
i. injection molding is performed with relatively low back pressure and extended transition zone screws.

19. A method as in claim 18 wherein the part is molded to have a class A or a class B surface.

20. A method as in claim 19 wherein the masterbatch, the admixture or both are substantially without coupling agent, compatibilzer or both.
